(19) United States
(12) Patent Application Publication
(10) Pub. No.: US 2014/0337728 A1
(43) Pub. Date: Nov. 13, 2014

(54) OPERATING ORACLE FORMS USING A WEB SERVICE

(71) Applicant: AURAPLAYER LTD., Tel Aviv (IL)

(72) Inventors: Mia Urman, Tel Aviv (IL); Yosef Nakash, Tel Aviv (IL)

(73) Assignee: AURAPLAYER LTD.

(21) Appl. No.: 14/338,633

(22) Filed: Jul. 23, 2014

Related U.S. Application Data
(63) Continuation-in-part of application No. 13/014,379, filed on Jan. 26, 2011.
(60) Provisional application No. 61/298,564, filed on Jan. 27, 2010.

(51) Int. Cl. H04L 29/08; G06F 3/0481

(52) U.S. Cl. CPC H04L 67/10; G06F 3/0481
USPC 715/709; 709/203

(57) ABSTRACT

A method for operating an Oracle Forms application using an alternative GUI (Graphical User Interface), the method comprising: providing a scenario file comprising a previously-intercepted communication between an Oracle Forms client and an Oracle Forms server; obtaining, from the alternative GUI, one or more input parameters associated with at least one user event of a session of the Oracle Forms server; preparing a new communication based on the scenario file and on the one or more input parameters; transmitting the new communication to the Oracle Forms server using a dispatcher component, thereby causing the Oracle Forms server to operate automatically and to output one or more output parameters; and displaying the one or more output parameters in the alternative GUI.

### CROSS REFERENCE TO RELATED APPLICATIONS

This application is a continuation-in-part of U.S. patent application Ser. No. 13/014,379, filed Jan. 26, 2011 and entitled “Computerized Toolset for Use With Oracle Forms”.

### FIELD OF THE INVENTION

The invention relates to Oracle Forms.

### BACKGROUND OF THE INVENTION

Oracle Forms, provided by Oracle Corp., is a component of Oracle Fusion Middleware, and is essentially a software product for creating interfaces and data entry systems for Oracle databases. In addition, Oracle Forms is widely used as a development platform for several of Oracle's packaged solutions versions, such as Oracle E-Business suite and Oracle Financials (formerly iFlex). Oracle Forms facilitates Oracle technology to design and build enterprise applications quickly and efficiently. Oracle Forms has an integrated development environment, and was originally developed to run server-side terminal sessions. Later on, Oracle Forms was ported to other platforms, including Windows, to function in a client-server environment. Oracle Forms applications take advantage of web technologies and service oriented architectures (SOA), and later versions were adapted and integrated with Java and web services.

In general, a DBMS (database management system) is toolset that organizes the storage of data. DBMS allows organizations to centralize, manage and control organization-wide data maintenance, manage integrated collections of data records, and manage the flow of corporate information. In large systems, a DBMS allows users and software to store and retrieve data in a structured way. The Oracle database (commonly referred to as Oracle RDBMS or simply Oracle) is an RDBMS (relational database management system) produced and marketed by Oracle Corp.

Oracle Database users may develop Oracle-compatible applications in various programming languages, such as Java and PL/SQL, with the use of tools such as Oracle JDeveloper, Oracle Forms and Oracle Reports. Oracle Forms relates to a software product for creating a visual UI (user interface) that interacts with an Oracle database.

Oracle Forms may support generation of multiple UI elements in order to interact with an Oracle database, including buttons, menus, scrollbars, text fields and graphics. In addition to the features of visual layout, editing Oracle Forms provides special functions called triggers, which are events triggered by the occurrence of user peripheral events such as keyboard strokes or mouse movements. Forms Builder is the component which may be used to create applications for interacting with Oracle databases

In Oracle Forms, the form's source code may be compiled into an “executable” file, that may be executed and interpreted by the OracleAS (Oracle application server) forms runtime module.

Oracle Forms Server (also “Forms server”) is an application server that is optimized for deploying Forms Developer applications to the Internet. Forms server may use the Forms Listener Servlet (a Java server side module) to start, stop, and communicate with the Forms runtime module. The Forms runtime module may be used to execute the form's source code contained in a particular Forms application. The Forms Listener Servlet may be used to manage the creation of a Forms runtime module for each client and manages the network communications between the client and its associated Forms runtime process.

Oracle Forms may use either Java Runtime Environment or Oracle JInitiator to run the GUI (graphical user interface) in conjunction with the OracleAS Forms Services and the Forms Listener Servlet, to provide the web-based forms runtime environment.

Oracle JInitiator, which is a JVM (Java Virtual Machine), may be called as a browser plug-in or an ActiveX control and used to for running web-based Oracle Forms client applications inside a web browser.

U.S. Pat. No. 6,070,177 to James Wei-Ching Kao et al. discloses a system for associating an audit history with a database form. A database document is displayed on a first portion of a display on network client computer. An audit history is displayed on a second portion of the display. The audit history contains information describing the transmission history of the document and any action taken with regard to the document. The audit history is updated automatically as the document is transmitted from one user to another user in the network. This patent is incorporated herein by reference in its entirety.

### SUMMARY

There is therefore provided, in accordance with an embodiment, a method for automatically operating an Oracle Forms application, the method comprising: intercepting, using a Listener component of the Oracle Forms application, a communication between the Oracle Forms application and an Oracle Forms server, and storing the intercepted communication; identifying, in the intercepted communication, data associated with at least one user event of the Oracle Forms application; replacing, in the intercepted communication, the identified data with new data corresponding to the user event of the Oracle Forms application, to produce a new communication; and transmitting the new communication to the an Oracle Forms server, using a Dispatcher component of the Oracle Forms application, thereby causing the Oracle Forms application to operate automatically.

In some embodiments, the method further comprises interfacing with a computer-telephone integration (CTI) system for receiving a caller identifier; and utilizing the caller identifier as at least a part of the new data, such that the automatic operation of the Oracle Forms application comprises displaying information associated with the caller.

In some embodiments, the method further comprises prior to replacing the identified data, providing a web-based user interface enabling a user to input at least a part of the new data.

In some embodiments, the method further comprises causing the Oracle Forms application to operate automatically comprises causing the Oracle Forms application to operate silently.

In some embodiments, causing the Oracle Forms application to operate automatically comprises causing the Oracle Forms application to operate visually, by displaying responses received from the Oracle Forms server.

There is further provided, in accordance with an embodiment, a method for auditing communications between a client running an Oracle Forms application and an Oracle Forms server, the method comprising: running a memory-resident auditing agent in the client; using the auditing agent, automatically interfacing with a Listener component of the Oracle Forms application, to intercept communications between the Oracle Forms application and an Oracle Forms server; transmitting at least a portion of the intercepted communications to an auditing server; and in the auditing server, parsing the transmitted communications, to produce an audit report which lists a set of actions performed by the client, along with a corresponding textual description of at least a portion of the Oracle Forms application.

There is further provided, in accordance with an embodiment, a method for monitoring communications between a client running an Oracle Forms application and an Oracle Forms server, the method comprising: running a memory-resident monitoring agent in the client; using the monitoring agent, automatically interfacing with a Listener component of the Oracle Forms application, to intercept communications between the Oracle Forms application and an Oracle Forms server; producing performance data, based on the intercepted communications, and transmitting the performance data to a monitoring server; and analyzing the performance data, to produce a performance report.

In some embodiments, analyzing of the performance data to produce the performance report is performed in the monitoring server.

In some embodiments, analyzing of the performance data to produce the performance report is performed in a management console.

There is further provided, in accordance with an embodiment, a method for monitoring communications between a client and an Oracle Forms server, the method comprising: running a memory-resident monitoring robot and a memory-resident monitoring agent in the client; remotely triggering the monitoring robot at pre-determined times, by a monitoring server, to generate and transmit a communication to an Oracle Forms server; intercepting, using the monitoring agent, a response to the communication received from the Oracle Forms server, and producing performance data; and analyzing the performance data, to produce a performance report.

In some embodiments, analyzing of the performance data to produce the performance report is performed in a monitoring server.

In some embodiments, analyzing of the performance data to produce the performance report is performed in a management console.

There is further provided, in accordance with an embodiment, a method for operating an Oracle Forms application using an alternative GUI (Graphical User Interface), the method comprising: providing a scenario file comprising a previously-intercepted communication between an Oracle Forms client and an Oracle Forms server; obtaining, from the alternative GUI, one or more input parameters associated with at least one user event of a session of the Oracle Forms server; preparing a new communication based on the scenario file and on the one or more input parameters; transmitting the new communication to the Oracle Forms server using a dispatcher component, thereby causing the Oracle Forms server to operate automatically and to output one or more output parameters; and displaying the one or more output parameters in the alternative GUI.

There is further provided, in accordance with an embodiment, a computer program product for operating an Oracle Forms application using an alternative GUI (Graphical User Interface), the computer program product comprising a non-transitory computer-readable storage medium having program code embodied therewith, the program code executable by at least one hardware processor to: provide a scenario file comprising a previously-intercepted communication between an Oracle Forms client and an Oracle Forms server; obtain, from the alternative GUI, one or more input parameters associated with at least one user event of a session of the Oracle Forms server; prepare a new communication based on the scenario file and on the one or more input parameters; transmit the new communication to the Oracle Forms server using a dispatcher component, thereby causing the Oracle Forms server to operate automatically and to output one or more output parameters; and display the one or more output parameters in the alternative GUI.

There is further provided, in accordance with an embodiment, a method for accessing an Oracle database, the method comprising: transmitting a message from a non-Java applet client to a listener servlet, the listener servlet running in an Oracle Forms server; processing the message by a Forms runtime process in the Oracle Forms server; and transmitting a request by the Forms runtime process to an Oracle database, the request being based on the processed message.

In some embodiments, the scenario file is a SOAP (Simple Object Access Protocol) web service.

In some embodiments, the scenario file is a REST (Representational State Transfer) web service.

In some embodiments, the causing of the Oracle Forms server to operate automatically comprises causing the Oracle Forms server to operate silently.

In some embodiments, the transmitting of the new communication to the Oracle Forms server is performed via an Application Program Interface (API), a command line, a Java Message Service (JMS) or a web service.

In some embodiments, the method is performed by a Service-Oriented Architecture (SOA) server.

In some embodiments, the method is performed by a cloud server.

In some embodiments, the alternative GUI is a web-based user interface enabling a user to input at least one of the one or more input parameters and to receive the one or more output parameters.

In some embodiments, the method further comprises enabling a user to design the web-based user interface using a visualization wizard.

In some embodiments, the alternative GUI is a native software application for a tablet computer, a smart phone, or a mobile device, the native application enabling a user to input at least one of the one or more input parameters and to receive the one or more output parameters.

In some embodiments, the method further comprises exposing the scenario file, as a web service, to an Oracle JDeveloper development environment.

In some embodiments, the program code is further executable to enable a user to design the web-based user interface using a visualization wizard.

In some embodiments, the program code is further executable to expose the scenario file, as a web service, to an Oracle JDeveloper development environment.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. The figures are listed below:

FIG. 1 shows a block diagram of an Oracle Forms toolset;

FIG. 2 shows a semi-pictorial view of an Oracle Forms toolbar;

FIG. 3 shows a flow chart of a method for automatically operating an Oracle Forms application;

FIG. 4 shows a flow chart of a method for auditing communications between a client running an Oracle Forms application and an Oracle Forms server;

FIG. 5 shows a flow chart of a method for monitoring communications between a client running an Oracle Forms application and an Oracle Forms server;

FIG. 6 shows a semi-pictorial view of an exemplary login window;

FIG. 7 shows a semi-pictorial view of an exemplary monitoring console; and

FIG. 8 shows a semi-pictorial view of an exemplary auditing console.

### DETAILED DESCRIPTION

An aspect of some embodiments relates to a computerized toolset for use with Oracle Forms. While Oracle Forms is a robust development tool, it has many limitations. Oracle Forms does not usually support modifying the form's functionality in real-time. In addition, Oracle Forms does not usually support integration with external applications. Oracle Form modification may require familiarity with PL/SQL syntax, as well as detailed knowledge of the application itself.

The toolset according to the present embodiments may be used to expedite and facilitate the process of customizing Oracle Form functionality at runtime and provide a flexible toolset for monitoring, auditing and restricting user actions, recording and playing user actions and integrating with a managerial dashboard, unified desktop and CTI (computer-telephone integration).

The toolset may be configured to performed automatic operations without user intervention. Form applications may be manipulated at runtime, including limiting and restricting user access to information and tracking the audit data of user actions. The toolset may be configured to provide real-time auditing and protection against fraud and internal threats. The toolset may be configured to generate real-time alerts in applications, ad-hoc locking of fields and stopping user actions as they occur in real-time, without changing the underlying application.

In addition, the toolset may be configured to support automatic execution of a wide variety of functions.

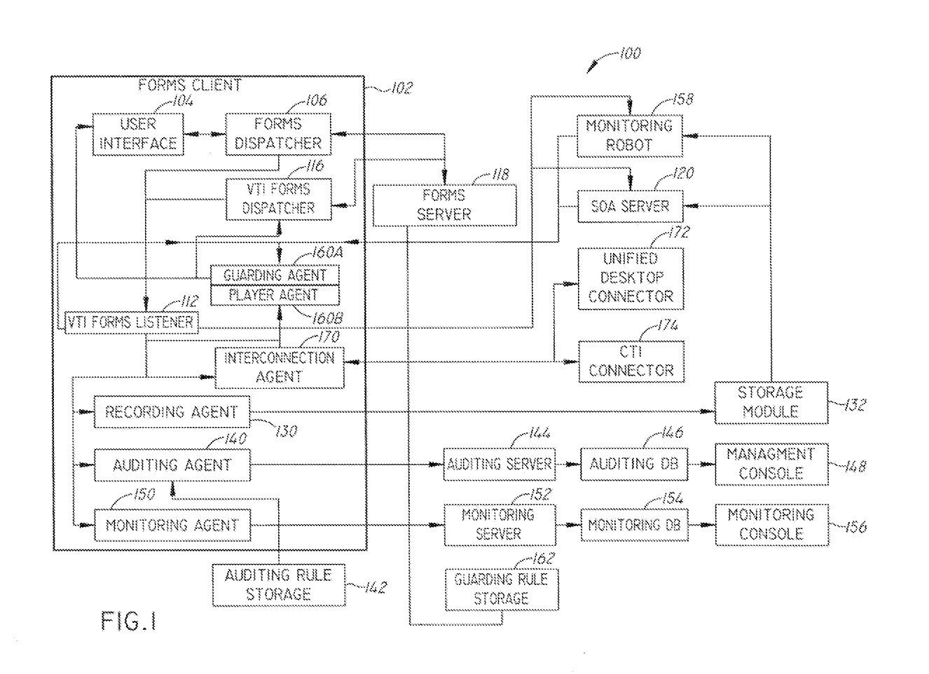

Reference is now made to FIG. 1, which shows a block diagram of an Oracle Forms toolset 100, according to some embodiments.

A Forms client 102 may be used within a web browser in order to interact with the end-user during a user session. Forms client 102 may include a user interface 104, which is used to interact with the user.

The term “user events” is an overall term used herein to describe all possible interactions of the user with an Oracle Forms application, including receiving input from the user, displaying screens and/or output to the user, user button clicks, mouse movements and/or the like.

The term “user events” may also refer to unique session identifiers, such as session ID, server hostname, port, URL of the session, usernames and/or other session-specific data.

In addition, Forms client 102 may include a Forms dispatcher 106. Forms dispatcher 106 may be configured to interact with a remote Oracle Forms server 118, including transmitting user events and receiving Oracle Forms server 118 reactions. A VTI (vendor tool interface) Forms Listener 112 may be configured to intercept communications between Forms dispatcher 106 and Oracle Forms server 118 (sometimes referred to as a “WebLogic managed server”). Additionally, VTI Forms Listener 112 may be configured to transfer relevant intercepted data to one or more other modules of Oracle Forms toolset 100.

Generally, Oracle Web Forms toolset 100 may include a recording agent 130 configured to support real-time recording of user events within Oracle Web Forms application. Such events may include user actions, data retrieved and changes made to Oracle Web Forms application data.

Recording agent 130 may be configured to receive and record intercepted data transmitted from VTI Forms Listener 112, including user session events as they are transmitted from Oracle Web Forms client application 102 (either JInitiator or Sun JVM java applet) to a Forms server 118.

Recording agent 130 may be configured to receive and record an entire sequence of user session events into a single or multiple scenario files. A “scenario file” may be, essentially, a script including commands for running the Forms application. Multiple scenarios files may be saved under unique names on a local or remote location and may be played back either on demand or as part of a workflow or an external business process.

In addition, each scenario file may be produced per user, per session and as a result, user session may produce multiple scenario files.

Recording agent 130 may be configured to support data based dynamic intervention to control the outcome of recorded user events. Recording agent 130 may be configured to support external tool access to recorded user session data, including: methods, triggers and query forms data without user intervention.

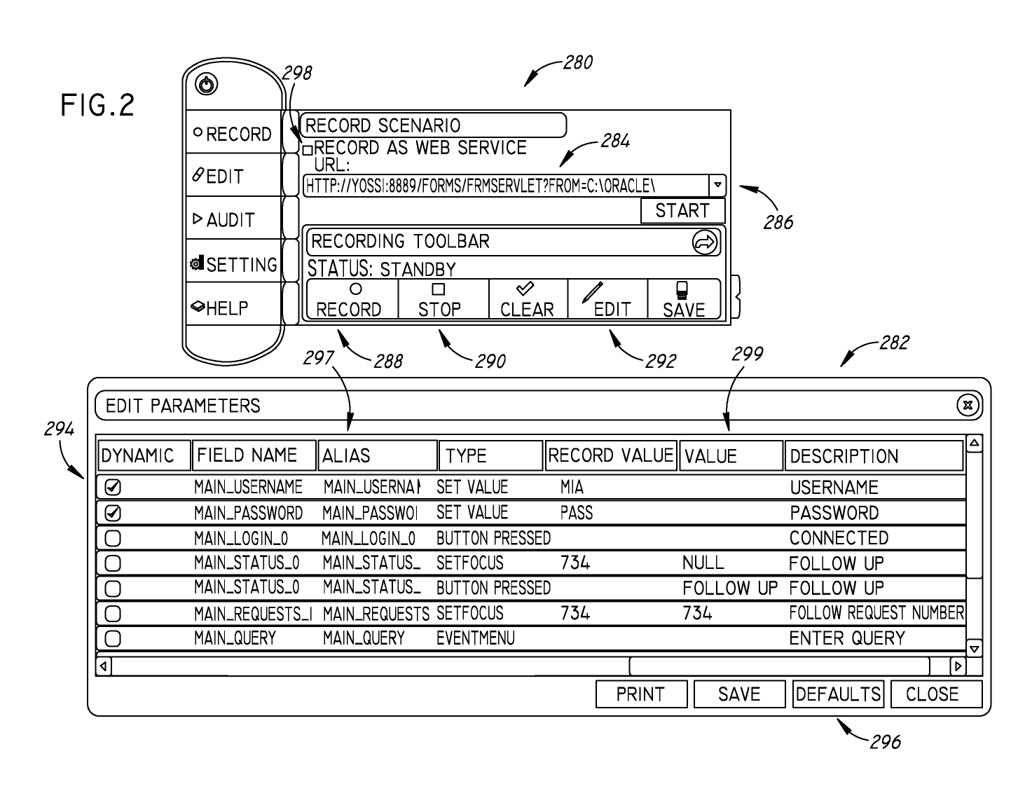

Reference is now made to FIG. 2 which shows a semi-pictorial view of an Oracle Forms recording toolbar 280, which may be configured to operate recording agent 130 of FIG. 1 and allow a user to record his actions and manage the recording process while working in the Oracle Forms application.

A Uniform Resource Locator (hereinafter “URL”) bar 284 may be used to allow the user to enter a Forms client 102 URL he wishes to record. Alternatively, the user may choose past URLs stored for convenience and displayed within a drop-down list 286 of stored URLs.

Once the URL of the Forms client 102 is entered, recording agent 130 may associate recording toolbar 280 with the session. Once the user starts interacting with a Forms client 102 (FIG. 1), recording agent 130 (FIG. 1) may be associated with Forms client 102 (FIG. 1) session. Recording agent 130 (FIG. 1) may be configured to support partial or full session recording

Recording toolbar 280 may include a “record” button 288 which may be used to begin the recording process, and a “stop” button 290 which may be used to end the recording process. Alternatively, recording agent 130 may be configured to begin the recording process whenever a specific URL is launched, without the need to use the record button 288. This is enabled by checking a “record as a web service” check box 298.

Once the record button 288 is clicked on recording toolbar 280, the recording process begins and any user events occurring in user interface 104 sessions are recorded and added to a scenario file. In addition, all values entered into fields in user interface 104 are recorded as input parameters.

Once the stop button 290 on the recording toolbar 280 is clicked, the recording session is complete and all values that were entered into fields during the record process can now be reviewed and edited.

Recording toolbar 280 may include an edit button 292 which may be used to open a parameters window 282.

Parameters window 282 may be used to view and edit saved scenario files having input and output parameters that were recorded during session recording. Parameters window 282 may be configured to display user event data, including: entered data, retrieved data and parameters captured during the session recording.

At the parameters window 282, the user may define which fields can be registered as input or output parameters for playback in which values are entered, or as an output parameter in which values received. A dynamic checkbox 294 may be configured to allow the user to choose whether given fields will be registered as static or dynamic during playback. If a field is deemed static, external systems may not alter these fields' values at runtime. A defaults button 296 may be configured to allow the user to return the parameter field value to the value that was entered by the user who recorded the original scenario. In FIG. 2, this would mean that the value column would get the recorded value column data. Once a field has been determined to be registered as static, the user may decide whether to keep the value that was set during the recording session as default or to enter a new default value 299, by editing the data found in the value column in the row of the table corresponding to the field.

In addition, parameters window 282 may include an alias 297 column which may be configured to allow the system administrator to add aliases to the input and output parameters, to serve as the reference names for parameters when used by external system, dynamically, during playback.

In an embodiment, a method for auditing communications between a client running an Oracle Forms application and an Oracle Forms server is provided. Auditing is, many times, a governmental requirement for financial institutions and banks Oracle Forms toolset 100 may be configured to provide a robust client-side auditing solution for Oracle Forms. Oracle Forms toolset 100 may be configured to enable a system administrator to audit and monitor all user actions performed over the Oracle Forms.

The term “audit trail” refers an extensive log of user events. The principle is to allow identification each step in from the comprehensive chronicle list of user events through the entire user interactions with Oracle Forms.

An example of an audit trail on an invoice issued by a vendor may include the following steps: Beginning with the receipt of the invoice, the document is tracked through Accounts Payable, all the way through to the issuance of a check or electronic payment to settle the debt.

Audit trail produced in the process of auditing may uncover attempts to manipulate the financial profile of an entity, perhaps in an attempt to cover up the fact that funds are missing or were misappropriated in some manner. In general, an audit trail may help to ensure that transactions are conducted smoothly, without user intervention and honestly, with the least amount of necessary steps employed in the process.

While many organizations choose to maintain a certain level of access logs, this might provide insufficient resolution due to several limitations. One of the limitations may be the result of missing records or missing field-level data. For example, some existing logs may contain information at the transaction level only, such as which users accessed which transaction at what time? In addition, critical information is still missing, such as which specific records and fields did the user access, and what the user did with the data. Another limitation may result from unregistered read-only actions. Some existing logs may record update activities only. Log may not register instances when information is accessed but not changed. However, such information is very important for preventing and investigating information leakage and for privacy protection. Another limitation may result of unregistered instances of incomplete activities. Some logs are maintained in disparate systems or applications which make it difficult to find and correlate relevant information.

Reference is made back to FIG. 1. According to some embodiments, an auditing agent 140 may be configured to run within Forms client 102. Auditing agent 140 may be configured to receive intercepted data transmitted from VTI Forms Listener 112 including user events as they are transmitted from Forms Dispatcher 106 to Forms server 118.

Auditing agent 140 may include an audit filter, which may include audit filtering rules including lists of specific Forms and specific fields to include or omit in the auditing process. Audit filter may be stored locally or remotely on an auditing rule storage 142 and may be written in an XML (extensible mark-up language) format. The audit filter may help to prevent overflowing of the auditing database with non-relevant data that is not needed to the auditing process. Audit filtering rules file may be created automatically or manually by the system administrator and may include auditing rules including: list of fields to be ignored, list of fields to be watched and list of fields of responses the user receives from the Forms server. When a user event occurs, auditing agent 140 may be configured to check whether a user event should be filtered according to the specified rules. If user event is slated to be ignored in the audit filter, it is not recorded to the audit database. The filtering level may be performed in a menu name level, a field names level, a full form level, item name level or form items such as buttons or key strokes or the like.

In addition, auditing agent 140 may be configured to produce auditing data including: analysis of user events, capturing the state of the form before each user event, description of user events, and the state of the form after the user events had occurred.

Auditing agent 140 may be configured to transmit auditing data to either local or remote auditing server 144, which may use either a local or remote auditing DB 146 to store auditing data. Alternatively, auditing data might be transferred to an auditing collection or presentation tool. Auditing data may be transmitted using several formats, including HTTP, XML, JMS, and/or the like.

A management console 148 may be configured to receive auditing data from auditing DB 146 and to perform audit data analysis. In addition, management console 148 may be configured to produce audit reports and allow a system administrator to review audit data and audit reports and to perform searches in audit data, for example, for all users who accessed a specific account number within a specific timeframe across any application or platform in the enterprise. Management console 148 may enable the system administrator to drill down on any user session data retrieved by the query and replay the user's actions screen by screen, keystroke by keystroke, without any changes to the underlying code and with no need for developer programming.

Auditing agent 140 may be configured to be automatically downloaded from a remote location to Forms client 102 by the use of an automatic distribution mechanism, for example a distribution mechanism similar to the one used to download the Oracle Form jar files. The automatic distribution mechanism may be configured to start automatically as the user launches Form client 102.

Auditing agent 140 may be configured to support users session events tracking at the form level optionally in real-time. Tracking user session events at the form level may include data reviewed by the user, Forms fields that the user selected or manipulated including user events that were not part of the interaction with the even if it was not stored to the DB.

In addition, auditing agent 140 may be configured to seamlessly generate a log of data changed or reviewed by each user, and actions performed by each user including: keys presses, button presses, and/or the like.

Inferior alternatives to the auditing functionality provided by the advantageous auditing agent 140 may require adding trigger functionality to the Oracle Forms during the development process to create a log mechanism to these applications. This may require adding PL/SQL code to be triggered at each event in the form during programming. In large enterprises adding PL/SQL code may require up to tens of thousands of online programs, this can translate into hundreds of programmer-months, not including the overhead on the database servers and additional maintenance required. The time, money and effort required for generating the detailed audit trail becomes exorbitant. Therefore, many organizations forgo this auditing and have mainly relied on other database auditing tools although they get an incomplete audit view, as data is usually presented in complex SQL statements and not as the user viewed the data on the screen. In addition, only data that was queried, inserted, updated and/or deleted will be recorded; if data was copies and pasted into a word processing program, for instance, there would be no record of the data manipulation since it did not occur in the database.

Auditing agent 140 may be configured to support various external auditing solutions including reporting tools, 3^{rd} party auditing software and other enterprise-wide auditing solutions to provide a raw data auditing data of user events of Oracle Forms systems. External auditing solutions may be located either locally or externally and reformat the output auditing data according to required specifications of external auditing solutions including: file, HTTP, DB, XML, Message Queue messages, JMS, and the like.

Therefore, auditing agent 140 may enable user event auditing using existing Oracle Forms, without modifying the Oracle Forms application code or functionality and without causing any overhead on the existing systems or network. Auditing agent 140 may be configured to support real-time and post-event auditing.

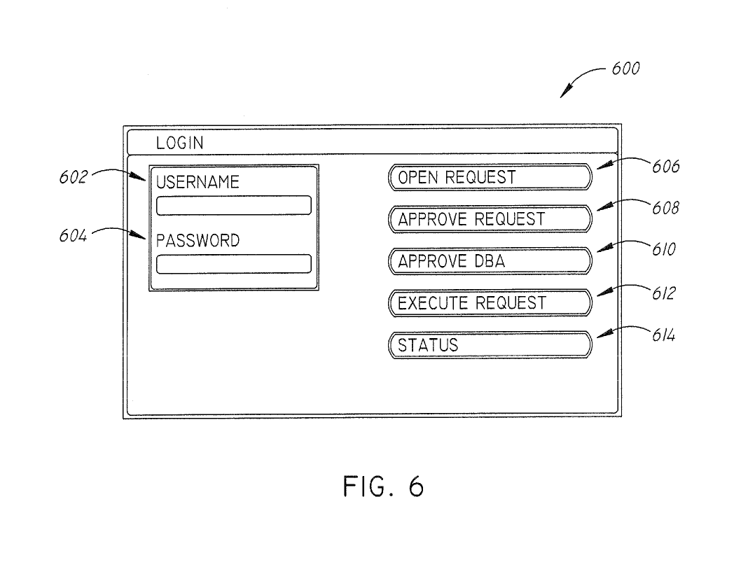

Reference is now made to FIG. 6, which shows an exemplary login window 600 of a Forms application. A username field 602 may be configured for input of a username. A password field 604 may be configured for input of a password. An open request button 606 may be configured to allow the user to open a request. An approve request button 608 may be configured to allow the user to approve a request. An approve DBA button 610 may be configured to allow the user to approve a DBA. An execute request button 612 may be configured to allow the user to execute a request. A status button 614 may be configured to allow the user to get a status.

The auditing process performed over login window 600 may output, as an example, an XML code such as the following one:

<MAIN>
<Action type=″WindowActivated″ window=″MAIN″ time=″11:01:46

02/12/2010″ clientIP=″192.168.1.102″ clientHostName=″yossi″ name=″MAIN″
label=″WindowActivated″ />

<Form windowName=″MAIN″ time=″11:01:46 02/12/2010″>
<Text label=″username″ value=″″ />
<Text label=″password″ value=″″ />
<Button label=″connect″ />
<Button label=″open request″ />
<Button label=″approve request″ />
<Button label=″approve DBA″ />
<Button label=″execute request″ />
<Button label=″status″ />
</Form>
<Action type=″Focus″ window=″MAIN″ time=″11:01:49 02/12/2010″

clientIP=″192.168.1.102″ clientHostName=″yossi″ name=″MAIN_USERNAME_0″
label=″ username ″ />

<Action type=″SetValue″ window=″MAIN″ time=″11:01:53 02/12/2010″

clientIP=″192.168.1.102″ clientHostName=″yossi″ name=″MAIN_USERNAME_0″
label=″ username ″ value=″MIA″ />

<Action type=″KeyPressed″ window=″MAIN″ time=″11:01:53 02/12/2010″

clientIP=″192.168.1.102″ clientHostName=″yossi″ name=″MAIN_USERNAME_0″
label=″KeyPressed″ value=″Tab″ />

<Form windowName=″MAIN″ time=″11:01:53 02/12/2010″>
<Text label=″ username ″ value=″MIA″ />
<Text label=″password″ value=″″ />
<Button label=″connect″ />
<Button label=″open request” />
<Button label=″approve request” />
<Button label=″approve DBA” />
<Button label=″execute request″ />
<Button label=″status″ />
</Form>
<Action type=″SetValue″ window=″MAIN″ time=″11:01:57 02/12/2010″

clientIP=″192.168.1.102″ clientHostName=″yossi″ name=″MAIN_PASSWORD_0″
label=″password″ value=″ORACLE″ />

<Action type=″Focus″ window=″MAIN″ time=″11:01:57 02/12/2010″

clientIP=″192.168.1.102″ clientHostName=″yossi″ name=″MAIN_LOGIN_0″
label=″connect″ />

<Form windowName=″MAIN″ time=″11:01:57 02/12/2010″>
<Text label=″ username ″ value ″ value=″MIA″ />
<Text label=″password″ value=″ORACLE″ />
<Button label=″connect″ />
<Button label=″open request” />
<Button label=″approve request” />
<Button label=″approve DBA” />
<Button label=″execute request″ />
<Button label=″status″ />
</Form>
<Action type=″ButtonPressed″ window=″MAIN″ time=″11:01:57 02/12/2010″

clientIP=″192.168.1.102″ clientHostName=″yossi″ name=″MAIN_LOGIN_0″
label=″connect″ value=″connect″ />

<Form windowName=″MAIN″ time=″11:01:57 02/12/2010″>
<Text label=″ username ″value ″ value=″MIA″ />
<Text label=″password″ value=″ORACLE″ />
<Button label=″connect″ />
<Button label=″open request” />
<Button label=″approve request” />
<Button label=″approve DBA” />
<Button label=″execute request″ />
<Button label=″status″ />
</Form>

</MAIN>

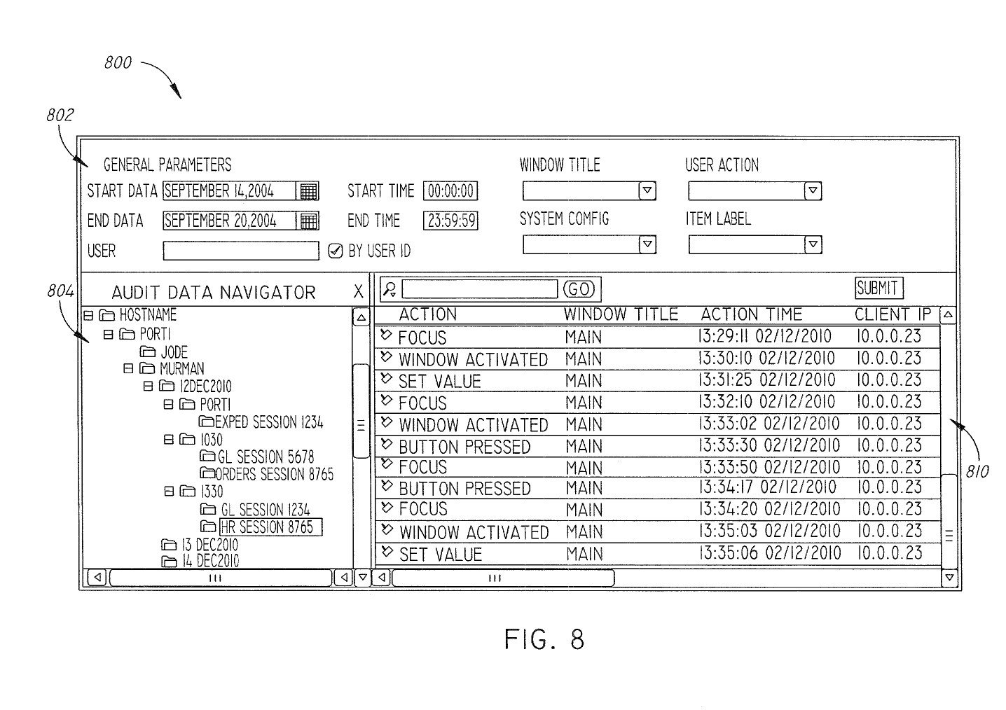

Reference is now made to FIG. 8, which shows an exemplary auditing console 800. Auditing console 800 may be configured to allow a system administrator to review auditing data and produce auditing reports. The auditing process performed over login window 600 (FIG. 6) may be reviewed in auditing console 800. A general parameters pane 802 may be configured to allow the system administrator to select the desired parameters to filter the auditing data. A navigation pane 804 may be configured to allow the system administrator to select the desired level of audit data. An output pane 810 may be configured to allow the system administrator to review the audit data output.

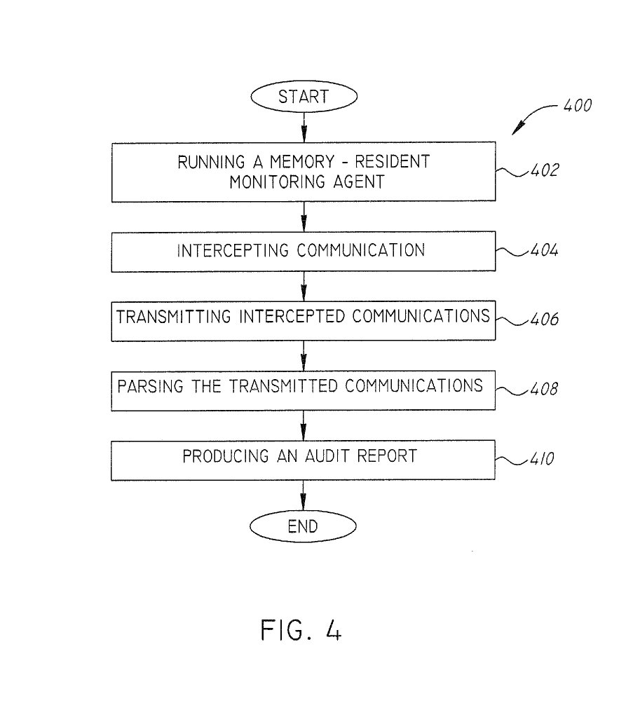

Reference is now made to FIG. 4, which shows a flow chart of a method 400 for auditing communications between a client running an Oracle Forms application and an Oracle Forms server. In a block 402, Forms client runs a memory-resident auditing agent.

In a block 404 the auditing agent automatically interfaces with a Forms Listener of the Oracle Forms application, to intercept communications between the Oracle Forms application and an Oracle Forms server.

In a block 404, the auditing agent transmits at least a portion of the intercepted communications to an auditing server. Optionally, the intercepted communications are stored in the auditing server and/or in a different database, file and/or the like.

In a block 408, the auditing server parses the transmitted communications.

In a block 410, the auditing server produces an audit report which lists a set of actions performed by the client, along with a corresponding textual description of at least a portion of the Oracle Forms application.

Reference is now made back to FIG. 1. In an embodiment, advantageously, Oracle Web Forms toolset 100 may include a guarding agent 160 configured to provide a real time data protection. Managing Operational risk is becoming an important aspect of risk management practice worldwide, including the financial sector. Operational risk is defined by the Basel committee as “direct or indirect loss resulting from inadequate or failed internal processes, people and systems or from external events.”

Protecting sensitive information from unauthorized manipulation and disclosure by its employees and management has become a major concern for large organizations worldwide. Adopting constant data protection and auditing as standard ongoing procedures in the organization may help large organizations to minimize the risk of data breach.

Oracle Web Forms toolset 100 may help organizations to inspect internal processes, including real-time activities of the users who perform these processes and the systems by which these processes are performed. The inspection may be carried by tracking end-user behavior patterns and triggering alerts on exceptions in real-time. According to an embodiment, oracle Web Forms toolset 100 may be used to inspect access to sensitive business data and identify internal fraud, data leakage and may block critical processes in real-time mitigating many operational risks.

Guarding agent 160A may offer a unique and innovative solution for mitigating this insider threat by continuously recording and analyzing all end-user activity across multiple applications and/or across multiple platforms in the enterprise

Guarding agent 160A may be configured to receive user events intercepted by recording agent 130 and collect valuable forensic evidence. User events data may be recorded along with labels defined in the form itself. In case that the underlying database tables have additional fields they are of no concern to the viewer and may be omitted from our logging. Only data that has been viewed or manipulated by the end user is recorded so the audit data is as targeted as possible.

In addition, guarding agent 160A may be configured to inspect, in real time, received user event data including user interaction with Forms server 118 and provide tracking of end-user activity.

Guarding agent 160A may be configured to inspect user events according to configurable restriction rules, and respond in real-time to user events according to response rules, including, for example, locking the current form session to restrict the user's continued work.

Guarding rule storage 162 may be located locally or remotely and configured to store restriction rules defining which data fields are restricted and under what conditions, whether restriction rules block or allow user events and response rules defining what actions should be taken upon violation of certain restriction rules. Restriction rules may include user behavior patterns.

Guarding agent 160A may be configured to selectively limit user access to sensitive data at several levels. As the user interacts with Forms client 102, guarding agent 160A may be configured to checks that the action performed by the user conforms to restriction rules. If the restriction rules allow the action to be performed, guarding agent 160A allows the action to be sent to the Forms server 118. The action is recorded along with the data received from the server, providing a second snapshot of the user activity and the data presented to the user. This second snapshot may be sent to the auditing agent 140 which processes the data as part of the auditing process. This process of record, filter and store is repeated for every user action to provide a series of snapshots of user activity and data viewed forming a detailed user history. If restriction rules do not allow the action to be performed, guarding agent 160A may block the action from being sent to Forms server 118. The action is recorded providing a second snapshot of the user activity and data presented to the user. This second snapshot may be sent to the auditing agent 140 which process the data as part of the auditing process.

An example for guarding agent 160A operation may include the following scenario. A system administrator may define restriction rules and response rules to perform if certain restriction rules have been violated, including: notifying the user that access to selected field is restricted, sending an email to system administrator logging the user attempt to review or modify the content of the selected field, optionally including in the email all of the time/date/user information associated with the attempted action. Alternatively, response rules may include a set of actions that executes automatically when a user attempts to access a restricted field, including, optionally, to the lock the current user's Forms session. Furthermore, guarding agent 160A may control the access to sensitive data by prompting a user to enter a password before either viewing or modifying the sensitive data. Guarding agent 160A operation works seamlessly in conjunction with existing Forms clients 102, without the need to reprogram or edit the Forms clients 102 themselves.

Optionally, the system administrator may include a response rule that blocks user attempts to access privileged data during specific hours or block user attempts to perform unauthorized actions on specific fields or with specific values. For example, an alert will popup and block user activity if a bank teller tries to access the bank president's bank records. In such a case, the alert triggers automatic suspension of the suspicious user in real-time.

In addition, response rules may include several ways to respond to violation of restriction rules including: sending email to system administrator, open a different form, stopping current session and displaying message box to the user, blocking the user in real time on the client side before the data or action reach Forms server 118, prompting the user to press a button or lock the Form, checking whether the current user has permission to access the requested records, preventing user interface 104 from displaying specific data, generating alerts on exceptions in real-time.

Oracle Web Forms toolset 100 may include a player agent 160B, which may be configured to process a scenario file, and orderly replay scenario commands stored therein. Scenario commands may be created by a recording process done by recording agent 130 or may be created or modified by the system administrator. Scenario commands may be stored in a scenario file.

In addition, player agent 160B may be configured to allow visual replay of user screens and keystrokes in any application, as if looking over a user's shoulder.

Once a scenario file has been created by recording agent 130 or by other tools, it may be replayed automatically with or without user interaction using either the same static data entered during the session recording process or as parameters by sending new data values dynamically. In addition, a scenario file may also be played back either silently, or visually, as part of an Oracle Form automation process.

Oracle Web Forms toolset 100 may include a service-oriented architecture (SOA) server 120 configured to provide SOA and web services capabilities to Oracle Web Forms toolset 100. A web service is a software system designed to support interoperable machine-to-machine interaction over a network. It has an interface described in a machine-processable format (specifically WSDL). Other systems interact with the Web service in a manner prescribed by its description using SOAP messages, typically conveyed using HTTP with an XML serialization in conjunction with other Web-related standards.

As an alternative to SOA server 120, Oracle Web Forms toolset 100 may utilize, at least partially, cloud computing. Hence, whenever SOA server 120 is referred to in the specification, a cloud computing implementation is also intended. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

1. On-demand self-service: a cloud consumer can unilaterally provision computing capabilities, such as server time and network storage, as needed automatically without requiring human interaction with the service's provider.

2. Broad network access: capabilities are available over a network and accessed through standard mechanisms that promote use by heterogeneous thin or thick client platforms (e.g., mobile phones, laptops, and PDAs).

3. Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

4. Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

5. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

1. Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

2. Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

3. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

1. Private cloud: the cloud infrastructure is operated solely for an organization. It may be managed by the organization or a third party and may exist on-premises or off-premises.

2. Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

3. Public cloud: the cloud infrastructure is made available to the general public or a large industry group and is owned by an organization selling cloud services.

4. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

5. A cloud computing environment is service oriented with a focus on statelessness, low coupling, modularity, and semantic interoperability. At the heart of cloud computing is an infrastructure comprising a network of interconnected nodes.

A scenario file playback may be initiated by a monitoring robot 158, SOA server 120, interconnection agent 170 connected to one or more external modules, such as unified desktop connector 172, CTI connector 174, or the like.

Alternatively, playing the scenario can be done per user or external system request by running it via API (Application Program Interface) or command line/Java/Web service/JMS.

A scenario file replay may be used to facilitate a web service, a java client or by a command line command, using either the recorded parameter data or different parameters. The recording and playback of all scenarios requires no intervention by a Forms developer and no knowledge of Forms or coding.

SOA server 120 may be configured to support running playback of scenario files in a silent mode. When running playback in silent mode, the scenario can be run without the browser and GUI of the form. Running playback without the browser open may be useful when the user wants to receive the OUT parameter values without running the forms session. Silent mode playback may be also used to integrate external application triggers, in batch mode without a client interface or in visual GUI mode. SOA server 120 may be further configured to execute a specific Oracle Forms scenario in response to remote third-party request. This request may be sending via API and/or Web services from any development technology, cloud services or mobile device.

SOA server 120 may be configured to enable administrators to create a web service that runs an Oracle Forms business scenario and returns output parameters. A “business scenario” may be any series of Oracle Forms actions. This feature is useful for several use cases. For example, a company uses different applications developed in different technologies and wishes to transfer parameters or other data between Oracle Forms and other applications. In this case, a system administrator may create a web service that runs an Oracle Forms business scenario that performs a query and outputs return values in a format appropriate for the external application. Storage module 132 may be configured to store scenario files, which may be executed as web services by SOA server 120.

A web service may take values from certain fields on the form and returns them to the calling function. Similarly, data obtained from an external application can be modified to conform to an Oracle Forms field and entered into a Form automatically by recording the data entry steps as a service. There are scripting languages or ‘integration’ platforms (such as business process execution language (BPEL) or Oracle Service Bus), that call different systems from the same script. Those scripts perform some actions on other components, run the web service application with dynamic parameters generated from previous actions, receive responses from the web service application, and use the web service application output for the next steps in the script.

SOA server 120 may be configured to allow external application to access and execute web services stored in storage module 132. In addition, according to some embodiments, performing operations (e.g., queries, data entry) on Oracle Forms from outside an Oracle application, such as by button presses, are enabled. In this case a button press is programmed to execute a recorded service.

The web service or external application need to operate the service to get the technical functionality locked in the Oracle Forms screen as an external function. Moreover, all of the aforementioned features are GUI-independent, as they are not dependent on a specific browser, applet or external tool in order to execute.

SOA server 120 may enable legacy technology to be part of an Enterprise Application Integration (EAI) workflow process thereby opening Oracle Forms up to the world of XML, BPEL and Java.

SOA server 120 may include a service manager. The service manager may allow a user to create, edit and/or test the web services which are based on Oracle Forms. Additionally, the service manager may enable the user to create an alternative GUI which then enables end-users to interact with the Oracle Forms using an enhanced interface. The alternative GUI may allow the user to trigger the Oracle Forms logic and utilize it in web services with a user friendly interface. The alternative GUI design process may start with a selection of a pre-recorded scenario file. As the user selects the pre-recorded scenario file, he or she may need to choose the requested input and output parameters that were recorded during the session.

This selection may allow the exclusive presentation of certain parameters which are desired by the user. The service manager may further allow the user to decide which input and output parameters should be visible or hidden in the alternative GUI. In addition, the service manager may allow the user to decide which input and output parameters in the alternative GUI should (a) have default values, such as username, ID, password, etc. (b) be variants that are dynamically entered at runtime, such as phone number, address, comments, etc. Additionally, all parameters would have details listed such as name, label, recorded label.

The service manager may include, for example, five components: a creation wizard, a manager, a tester, a designer and a diagnostic tool.

The creation wizard may automatically create a simple object access protocol (SOAP) web service and/or a representational state transfer (REST) web service from a scenario file. The manager may allow editing and modifying of the automatically created web services, including data parameters such as name, label, recorded label, etc. and enable and/or disable capabilities such as visible, read only, etc. In this regard, the manager may act similar to parameters window 282 of recording toolbar 280 (FIG. 2).

The tester may translate information about the operations that make up the web services (such as the back-end components that implement the operations, data type mapping information, return values of the operations, etc.) into an XML result. The tester may further run a test on the file and verify the output.

The diagnostics component may view log files, error messages and debug the Oracle Forms-based web services. The diagnostics component may further include backup and restore capabilities, in which SOAP and/or REST web services may be backed up and restore when desired.

The designer may generate an default UI page based on the requested web services. For example, in order to generate an HTML page, the designer may include a software component such as XSL; XSL is a language used to transform an XML document to an HTML format document. The designer may allow the user to simply convert the tester output file to an HTML file. This is made in order for the requested data to be viewable in the alternative GUI.

The designer may also include a visualization wizard. The visualization wizard may allow the user to choose a web service which is already managed in SOA server 120 and to extract an HTML page from the chosen web service. The visualization wizard may further build an alternative GUI comprising a one or more HTML pages with one or more forms. The alternative GUI may include: a form comprising a parameters input, a form comprising a search of scenario records by user request, a form which generates a response with the output parameters, enablement of status bar messages, and presenting the error message pages etc. The visualization wizard may further allow the user to define visual properties such as header, footer text, fonts, text colors and/or images in order to create a default layout.

In addition, the service manager may allow the web services to be utilized in a JDeveloper development environment. JDeveloper, which is an integrated development environment (IDE), may allow a user to develop the alternative GUI via development languages such as Java, XML, SQL, PL/SQL, HTML, JavaScript, BPEL and/or PHP. The JDeveloper may automatically create an Oracle application development framework (Oracle ADF) data control which is an end-to-end Java Enterprise Edition-based framework. This data control can be bound to Oracle ADF faces components and/or to mobile UI components. The alternative GUI may call the pre-recorded Oracle Forms business process in silent mode and return data parameters and Forms messages from the resulting scenario.

The service manager may further allow the user to develop the alternative GUI in an external development language, such as Java, .Net, etc. In order for the user to do so, he or she may need to obtain the web service URL which is stored in SOA server 120. Once the web service URL is copied, the user can use the SOAP/REST web service to develop the alternative GUI via the external development language.

Furthermore, the service manager may expose WSDL (Web Services Description Language) description of the web services that call the recorded scenario. WSDL is an XML-based interface definition language that is used for describing the functionality offered by a web service. An example of a WSDL description is shown below:

<?xml version=“1.0” encoding=“UTF-8”?>
<description xmlns=“http://www.w3.org/ns/wsdl”

xmlns:tns=“http://www.tmsws.com/wsdl20sample”
xmlns:whttp=“http://schemas.xmlsoap.org/wsdl/http/”
xmlns:wsoap=“http://schemas.xmlsoap.org/wsdl/soap/”
targetNamespace=“http://www.tmsws.com/wsdl20sample”>

<!-- Abstract type -->

<types>

<xs:schema xmlns:xs=“http://www.w3.org/2001/XMLSchema”

xmlns=“http://www.tmsws.com/wsdl20sample”
targetNamespace=“http://www.example.com/wsdl20sample”>

<xs:element name=“request”> ... </xs:element>
<xs:element name=“response”> ... </xs:element>

</xs:schema>

</types>

<!-- Abstract interfaces -->

<interface name=“Interface1”>

<fault name=“Error1” element=“tns:response”/>
<operation name=“Get” pattern=“http://www.w3.org/ns/wsdl/in-out”>

<input messageLabel=“In” element=“tns:request”/>
<output messageLabel=“Out” element=“tns:response”/>

</operation>

</interface>

<!-- Concrete Binding Over HTTP -->

<binding name=“HttpBinding” interface=“tns:Interface1”

type=“http://www.w3.org/ns/wsdl/http”>

<operation ref=“tns:Get” whttp:method=“GET”/>

</binding>

<!-- Concrete Binding with SOAP-->

<binding name=“SoapBinding” interface=“tns:Interface1”

type=“http://www.w3.org/ns/wsdl/soap”
wsoap:protocol=“http://www.w3.org/2003/05/soap/bindings/HTTP/”
wsoap:mepDefault=“http://www.w3.org/2003/05/soap/mep/request-

response”>

<operation ref=“tns:Get” />

</binding>

<!-- Web Service offering endpoints for both bindings-->

<service name=“Service1” interface=“tns:Interface1”>

<endpoint name=“HttpEndpoint”

binding=“tns:HttpBinding”
address=“http://www.example.com/rest/”/>

<endpoint name=“SoapEndpoint”

binding=“tns:SoapBinding”
address=“http://www.example.com/soap/”/>

</service>

</description>

Once published by SOA server 120 and the service manager, the pre-recorded scenarios can run through the alternative GUI which plays back the Oracle Forms business process silently on Form server 118. SOA server 120 and the service manager may further allow any third-party applications such as ADF, Java, .Net, mobile applications, etc., to call these scenarios from any technology or device that can connect to the Forms application. This process allows integration of the Oracle Forms business processes and data parameters with other technologies, silently and seamlessly.

The service manager may enable the modification of the alternative GUI to any kind of a computerized unit display, such as tablet computers, laptop computers, desktop computers, smartphones, or other wireless enabled devices such as smart watches, smart eyewear, smart appliances, GPS devices or other etc. The service manager may also enable the adaptation of the alternative GUI on any kind of web browser and/or display size. Furthermore, a native software application may be programmed by utilizing the web services, thereby enabling end-users to enjoy Oracle Forms functionality using software applications for iOS, Android, Windows Phone, Tizen, ChromeOS, FirefoxOS, or etc.

In another use case, a company stores much detailed information in an Oracle database, yet the company would like to expose only select fields in the Form to public users. For example, on a customer service website the customer enters a personal ID no. and the website returns an associated name (e.g., John Smith) without any additional details. The Company may store customer ID, customer names and additional customer information in an Oracle Forms system. The system administrator may record a script that takes a personal ID no. as a dynamic IN parameter and returns an associated name as an OUT parameter. The web service then takes this OUT parameter and displays it to the customer, inter alia, in a web browser application not using Oracle Forms. When a user runs this application, he enters an ID no., and receives his name without being exposed to all of the data in the Oracle Form.

Web services may provide functional building-blocks of code accessible over standard Internet protocols independent of platforms and programming languages, and can therefore be used to implement a software-as-a-service (SAAS) architecture. SOA may include several features including: reuse, granularity, modularity, composability, componentization and interoperability, standards-compliance (both common and industry-specific), services identification and categorization, provisioning and delivery, monitoring and tracking.

Web services may represent either new applications or just wrappers around existing legacy systems to make them network-enabled. According to present embodiments, a user may write a script in any programming language that can then run specific encapsulated Oracle Forms business logic in scenario based macros that were pre-recorded by the system administrator.

In order to create an SOA service, the system administrator may take the following steps: record a scenario that performs actions on Oracle Forms—a business scenario; define input and output parameters; save the service as a scenario file. Recording toolbar 280 may be configured to allow the system administrator to record a scenario file by checking a “Record as a web service” 298 checkbox.

In addition, the system administrator may decide to capture output parameters to later enable sending the captured field as output data to the calling application. For example, if the form input is a user name and the output captured is a corresponding user ID number. In this example, the user records a scenario of entering a user name into an Oracle Form and then capturing the user ID number from the Oracle Form to later be transferred to the calling application. Using any script or programming language, the user can then call this SOA service by executing a required web service which may be stored in storage module 132. In addition, a web service may be executed through a web service, java program or command line, with the required input parameters (in the example case, user name), and can use the output parameter (in the example case, user ID number). The output parameter can be used by the Web service to perform other actions.

In lieu of or in addition to operating the Oracle Forms server via an alternative GUI, present embodiments may enable a client to access an Oracle database, through the Oracle Forms server, without needing any Java applet running at the client. That is, a communication (also a “message”) may be transmitted from a non-Java applet client (e.g. a computing device connected, via a network, to the Oracle Forms server) to a listener servlet running in the Oracle Forms server. Then, as known in the art, the listener servlet may transmit the communication to a Forms runtime process, which also runs in the Oracle Forms server. The Forms runtime process may process that communication and transmit a request (i.e. a database query) which is based on the processed communication to an Oracle database which is in network communication with the Oracle Forms server. Once the Oracle database replies to the query, the Oracle Forms server may transmit the reply back to the client.

The communication from the non-Java applet client may be formatted, in some embodiments, as XML. Optionally, an XML-to-binary converter (e.g. the Dispatcher) may be executed at the client, such that the communication is transmitted, over the network, in binary format. The XML may include commands which are aimed at forming the database query; for example, the commands may include creation of a database entry, updating of a database entry, deletion of a database entry, etc.

Oracle Web Forms toolset 100 may include an interconnect agent 170 configured to provide an interface between player agent 160B, VTI Forms Listener 112 and external modules of Web Forms toolset 100 that may exist external to the Forms client 102.

Interconnect agent 170 may be configured to allow transfer of data and business context between various business systems and player agent 160B, as well as to trigger form functions based on functions performed in external applications. Interconnect agent 170 may be configured to receive input data from an external module, reformat the input data according to the external module type and transmit the input data to player agent 160B. In addition, interconnect agent 170 may be configured to receive output data from VTI Forms listener 112, reformat the output data according to the appropriate external module type and transmit the output data to the appropriate external module.

Interconnect agent 170 may be configured to allow the external module to interact with player agent 160B and VTI Forms listener 112 by running a scenario file and thereby establish a visually integrated indirect interface with Forms server 118, which is similar to the interface between Forms client 102 and Forms server 118. In addition to handling the business integration, interconnect agent 170 may also receive session data about the health of the Oracle Form client, received from the Forms server via the VTI Forms listener. Such data may include “keep-alive” status, messages, alerts, and error messages which may sometimes not even be shown to the user.

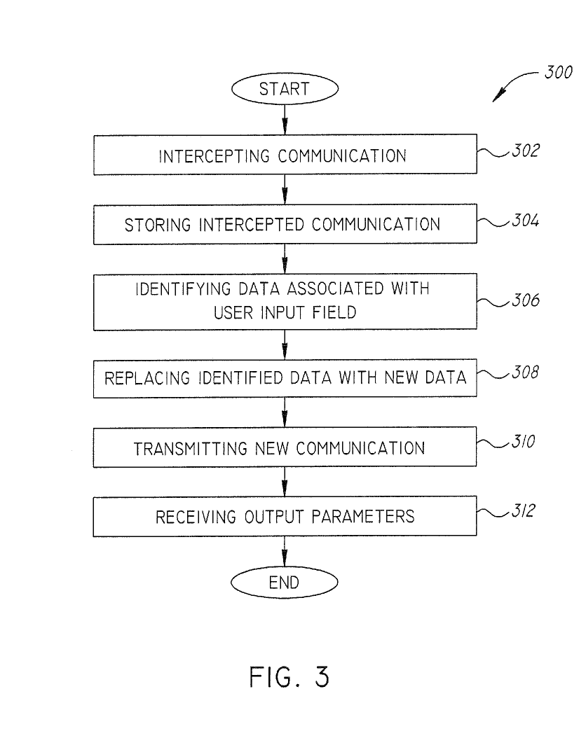

Reference is now made to FIG. 3, which shows a flow chart of a method 300 for automatically operating an Oracle Forms application.

In a block 302, a recording agent uses a VTI Forms listener to intercept communications between the Oracle Forms application and an Oracle Forms server.

In a block 304, the recording agent stores the intercepted communication into storage module.

In a block 306, the recording agent identifies, in the intercepted communication, data associated with at least one user input field and may optionally set fields to be captured as output parameters of the Oracle Forms application.

In a block 308, the recording agent replaces, in the intercepted communication, the identified data with new data corresponding to the user input field of the Oracle Forms application. One or more of the following modules: monitoring robot, SOA server, unified desktop connector, CTI connector, toolset API produces a new communication.

In a block 310, a player agent receives the new communication from an external module and transmits the new communication to the Oracle Forms server, using a Dispatcher component of the Oracle Forms application, thereby causing the Oracle Forms application to operate automatically, either silently or visually with the interconnect agent.

In a block 312, the external application or one or more of the following modules: monitoring robot, SOA server, unified desktop connector, CTI connector, toolset API may receive the output parameter values as defined in the scenario file.

Reference is now made back to FIG. 1. CTI (Computer Telephony Integration) is widely used by organizations that provide telephony services or customer service interaction via telephone. Typically, when a customer calls a telephony service the customer is prompted to enter his details. The customer is subsequently redirected to a customer service representative for support. In a best-case scenario, when the customer is redirected to a customer service representative the customer details automatically pop-up on the support application screen.

Oracle Web Forms toolset 100 may include a CTI connector 174 configured to provide a framework for integration of Oracle forms with CTI systems.

The system administrator can record a typical scenario performed in a call center, for example, a customer service agent taking a service call. Here, in real-time, the agent performs a series of operations including: receiving customer details as input; and querying the database for the customer's history and other relevant information. The system administrator may define the customer details as dynamic IN parameters. After the initial recording, the scenario is saved to a file. The scenario is set to run automatically when a call is received. When a call is received, it is answered by an automated phone operator that prompts the user to enter his information, inter alia, by speaking the information into the phone or punching in numbers on the user's telephone handset. The customer details entered by the customer are the dynamic IN parameters used by the scenario. When the call is transferred to a customer service representative, player agent 160B may be configured to run a scenario file and send the query output to the customer service representative through user interface 104. This feature improves the service and the response time as the customer service representative does not need to perform any operations in order to retrieve relevant customer data.

CTI connector 174 may be configured to interact with the interconnection agent 170 and run the scenario file by sending CTI data to interconnection agent 170 after receiving the input parameters entered into the CTI connector 174.

The provided framework for integration of Oracle forms with CTI may save valuable time and resources. When the call is transferred to a customer service representative the query output form generated by the scenario is already displayed to the customer service representative, which can immediately attend to the customer's needs.

Access to timely and accurate information may be crucial to corporate survival. Sometimes it is not enough to integrate databases; it is highly advantageous to provide managers with a management dashboard or unified desktop as a holistic view of all aspects of the business from various systems at a single glance. A unified view of multiple business processes allows decision makers to make accurate decisions quickly.

Oracle Web Forms toolset 100 may include a unified desktop connector 172 which may be configured to allow sharing of business information across external applications which may be visually integrated in a common desktop or dashboard architecture. Unified desktop connector 172 may be configured to visually integrate multiple systems and provide a single point of contact for all systems to be integrated on the front end. Values are entered into Oracle Forms fields automatically, through a unified desktop interface, and Oracle Forms business logic runs automatically by running the business scenario from one or more external modules. Furthermore, unified desktop connector 172 may enable extracting values from Oracle Form fields for integration with outside systems. In addition, unified desktop connector 172 may be configured to provide visual client side integration of multiple, independent, business-related systems.

Each of the systems being integrated into the unified desktop may be developed using a different technology. In order to visually integrate multiple systems in a single user interface there is a need to support the passing of parameters in two-way client side integration with Oracle Forms. Unified desktop connector 172 may be configured to use two-way client side integration with Oracle Forms which allows the unified desktop connector 172 to run Oracle Forms business processes and extract out parameters from Oracle Forms systems for the use of other systems contained in the unified desktop.

According to an embodiment, Oracle Web Forms toolset 100 may include a monitoring agent 150 configured to run within Forms client 102 and receive intercepted session data transmitted from VTI Forms Listener 112 including user session events as they are transmitted from Forms Dispatcher 106 to Forms server 118. Monitoring agent 150 may be configured to calculate and track the performance and network statistics of each individual client-side operation performed by each user. In addition, the intercepted data may be recorded, so that it is later possible to analyze the performance of specific user events of interest.

Monitoring system performances over a large scale computing enterprise systems is becoming an important and complex task. System downtime and outages cost companies millions each year and identifying system weaknesses and performance bottlenecks in advance can save companies much headache and valuable resources. An increasing number of corporations consider high utilization of computational resources as a major goal in their business model. The ability to monitor system performances in real time is an important tool for achieving high utilization of computational resources, identifying problem areas and system bottlenecks and receiving quick response alerts and real-time notification on system performance irregularities when necessary.

Monitoring agent 150 may be configured to track time span, server response time and network throughput for each action. Monitoring agent 150 may be configured to collect the data from all the Oracle Forms' users on the client side, process the collected data, and send it to the a monitoring server 152 which may be configured to perform further data processing over the collected monitoring data and store it in a monitoring DB 154 which may be used to store monitoring data.

A monitoring robot 158 may be configured to run a silent playback of scenario files according to a pre-determined monitoring schedule. System administrator may choose the monitoring schedule and the scenario files which will be used to monitor the system performance.

In addition monitoring robot 158 may be configured to produce monitoring data in a similar way to monitoring agent and send monitoring data to monitoring server 152 in a similar why to monitoring agent 150.

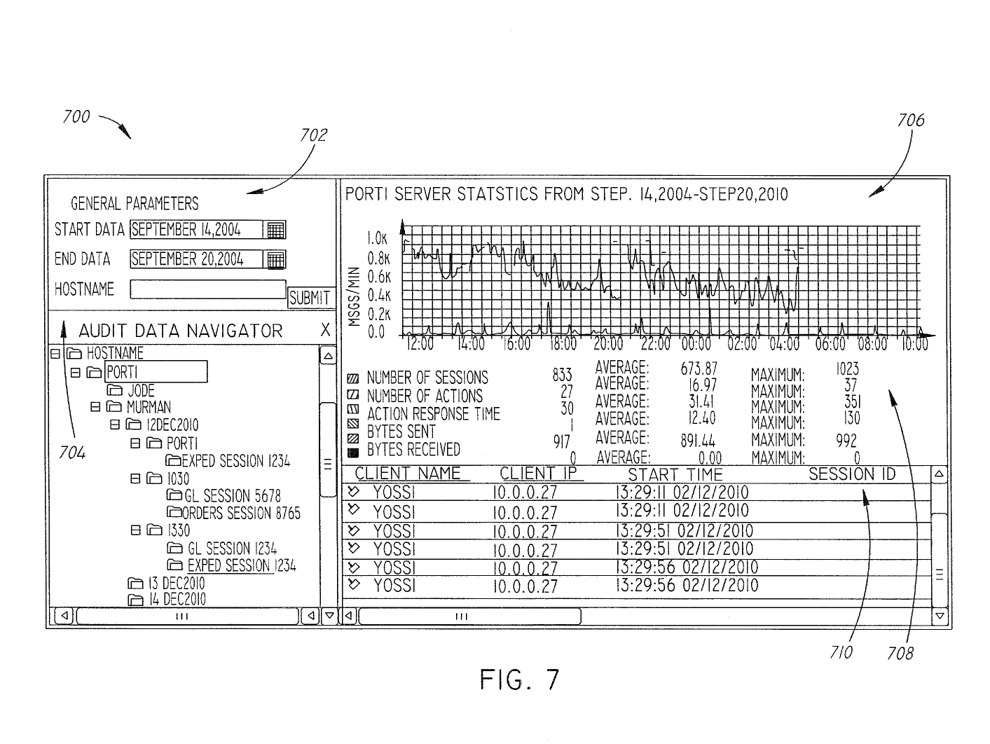

Reference is now made to FIG. 7, which shows a semi-pictorial view of an exemplary monitoring console 700, which is similar to monitoring console 156 (FIG. 1), and is shown here in greater detail.

Monitoring console 700 may be configured to receive monitoring data from monitoring DB 154, and to further allow the system administrator to review system performance reports.

A general parameters pane 702 may be configured to allow the system administrator to select the desired parameters according to which the monitoring data is filtered, such as a data range, a host name and/or the like.

A navigation pane 704 may be configured to allow the system administrator to select the desired level of monitoring data.

A statistics graph 706 may show the monitoring data visually, over various selectable axes.

A summary pane 708 may be configured to allow the system administrator to review a summary or an entirety of the monitoring data. This summary optionally serves as the basis for statistics graph 706.

An output pane 710 may be configured to allow the system administrator to review the raw monitoring data output.

In addition, monitoring console 700 may be configured to produce an additional monitoring report including availability report, error report, usage report, system functionality report and/or the like.

Alternatively, monitoring DB 154 and/or monitoring server 152 (FIG. 1) may be configured to deliver monitoring data to external third-party software solution used for further processing and review of monitoring data.

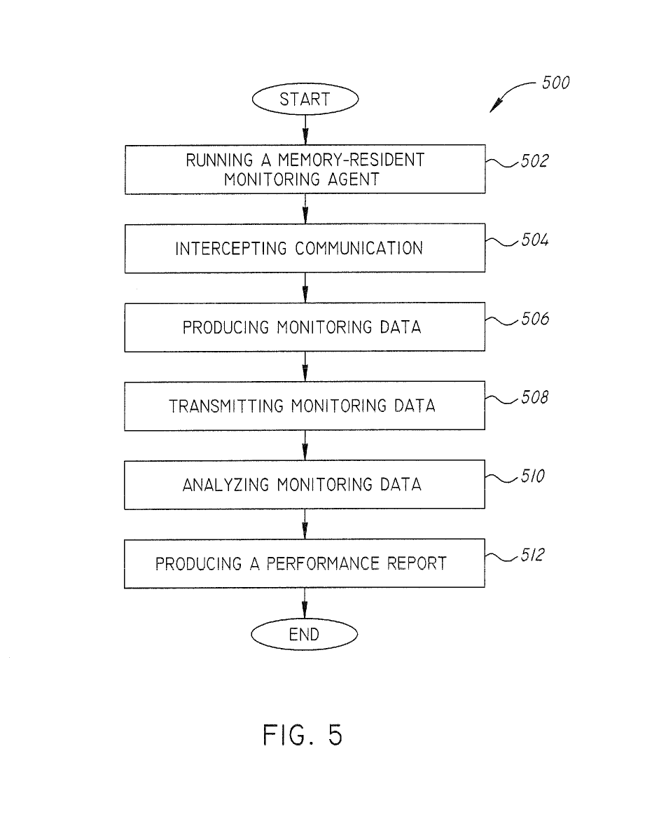

Reference is now made to FIG. 5, which shows a flow chart of a method 500 for monitoring communications between a client running an Oracle Forms application and an Oracle Forms server.

In a block 502, a Forms client runs a memory-resident monitoring agent.

In a block 504, the monitoring agent automatically interfaces with a Forms Listener of the Oracle Forms application, to intercept communications between the Oracle Forms application and an Oracle Forms server.

In a block 506, the monitoring agent produces performance data.

In a block 508, the monitoring agent transmits the performance data to a monitoring server.

In a block 510, the monitoring server parses and statistically analyzes the performance data. Optionally, the performance data is stored in a non-volatile memory device, such as a database, a file and/or the like.

In a block 512, the monitoring console produces a performance report based on the monitoring data.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While a number of exemplary aspects and embodiments have been discussed above, those of skill in the art will recognize certain modifications, permutations, additions and sub-combinations thereof. It is therefore intended that the following appended claims and claims hereafter introduced be interpreted to include all such modifications, permutations, additions and sub-combinations as are within their true spirit and scope.

In the description and claims of the application, each of the words “comprise” “include” and “have”, and forms thereof, are not necessarily limited to members in a list with which the words may be associated.

What is claimed is:

1. A method for operating an Oracle Forms application using an alternative GUI (Graphical User Interface), the method comprising:
providing a scenario file comprising a previously-intercepted communication between an Oracle Forms client and an Oracle Forms server;
obtaining, from the alternative GUI, one or more input parameters associated with at least one user event of a session of the Oracle Forms server;
preparing a new communication based on the scenario file and on the one or more input parameters;
transmitting the new communication to the Oracle Forms server using a dispatcher component, thereby causing the Oracle Forms server to operate automatically and to output one or more output parameters; and
displaying the one or more output parameters in the alternative GUI.

2. The method according to claim 1, wherein the scenario file is a SOAP (Simple Object Access Protocol) web service.

3. The method according to claim 1, wherein the scenario file is a REST (Representational State Transfer) web service.

4. The method according to claim 1, wherein the causing of the Oracle Forms server to operate automatically comprises causing the Oracle Forms server to operate silently.

5. The method according to claim 1, wherein the transmitting of the new communication to the Oracle Forms server is performed via an Application Program Interface (API), a command line, a Java Message Service (JMS) or a web service.

6. The method according to claim 1, wherein the method is performed by a Service-Oriented Architecture (SOA) server.

7. The method according to claim 1, wherein the method is performed by a cloud server.

8. The method according to claim 1, wherein the alternative GUI is a web-based user interface enabling a user to input at least one of the one or more input parameters and to receive the one or more output parameters.

9. The method according to claim 8, further comprising enabling a user to design the web-based user interface using a visualization wizard.

10. The method according to claim 1, wherein the alternative GUI is a native software application for a tablet computer, a smart phone, or a mobile device, the native application enabling a user to input at least one of the one or more input parameters and to receive the one or more output parameters.

11. The method according to claim 1, further comprising exposing the scenario file, as a web service, to an Oracle JDeveloper development environment.

12. A computer program product for operating an Oracle Forms application using an alternative GUI (Graphical User Interface), the computer program product comprising a non-transitory computer-readable storage medium having program code embodied therewith, the program code executable by at least one hardware processor to:
provide a scenario file comprising a previously-intercepted communication between an Oracle Forms client and an Oracle Forms server;
obtain, from the alternative GUI, one or more input parameters associated with at least one user event of a session of the Oracle Forms server;
prepare a new communication based on the scenario file and on the one or more input parameters;
transmit the new communication to the Oracle Forms server using a dispatcher component, thereby causing the Oracle Forms server to operate automatically and to output one or more output parameters; and
display the one or more output parameters in the alternative GUI.

13. The computer program product according to claim 12, wherein the scenario file is a SOAP (Simple Object Access Protocol) web service.

14. The computer program product according to claim 12, wherein the scenario file is a REST (Representational State Transfer) web service.

15. The computer program product according to claim 12, wherein the causing of the Oracle Forms server to operate automatically comprises causing the Oracle Forms server to operate silently.

16. The computer program product according to claim 12, wherein the transmitting of the new communication to the Oracle Forms server is performed via an Application Program Interface (API), a command line, a Java Message Service (JMS) or a web service.

17. The computer program product according to claim 12, wherein the at least one hardware processor is comprised in a Service-Oriented Architecture (SOA) server.

18. The computer program product according to claim 12, wherein the at least one hardware processor is comprised in a Cloud server.

19. The computer program product according to claim 12, wherein the alternative GUI is a web-based user interface enabling a user to input at least one of the one or more input parameters and to receive the one or more output parameters.

20. The computer program product according to claim 12, wherein the program code is further executable to enable a user to design the web-based user interface using a visualization wizard.

21. The computer program product according to claim 12, wherein the alternative GUI is a native software application for a tablet computer, a smartphone or a mobile device, the native application enabling a user to input at least one of the one or more input parameters and to receive the one or more output parameters.

22. The computer program product according to claim 12, wherein the program code is further executable to expose the scenario file, as a web service, to an Oracle JDeveloper development environment.

23. A method for accessing an Oracle database, the method comprising:
transmitting a message from a non-Java applet client to a listener servlet, the listener servlet running in an Oracle Forms server;
processing the message by a Forms runtime process in the Oracle Forms server; and
transmitting a request by the Forms runtime process to an Oracle database, the request being based on the processed message.
